(19) United States
(12) Patent Application Publication
(10) Pub. No.: US 2004/0036778 A1
(43) Pub. Date: Feb. 26, 2004

(54) Slit camera system for generating artistic images of moving objects

(76) Inventor: Frederic Vernier, Romans (FR)

Correspondence Address: Patent Department, Mitsubishi Electric Research Laboratories, Inc., 201 Broadway, Cambridge, MA, 02139, US

(21) Appl. No.: 10/225,877

(22) Filed: Aug. 22, 2002

(51) Int. Cl. H04N 5/228

(52) U.S. Cl. 348/222.1

(57) ABSTRACT

A slit camera system and method generates and displays an image of a moving object. First, a user defines one or more scan lines. Then, a sequence of frames of the moving object are acquired. From each frame, pixels corresponding to a current position of the scan line are selected. The selected pixels are stored in a static portion of an image buffer and remaining pixels of the frame are stored in a dynamic portion of the image buffer without overwriting any pixels of the static portion to display a distorted image of the moving object.

### FIELD OF THE INVENTION

The invention relates generally to systems for generating and displaying images of a moving object, and more particularly to compositing an output image according to scan lines moving across a sequence of frames.

### BACKGROUND OF THE INVENTION

A slit camera is typically used to take images of fast moving objects in a scene, e.g., horses at the finish line of a race course. In a traditional slit camera, an aperture, in the form of a narrow vertical slit, is disposed between the lens and the film, and the film moves in an opposite direction to the moving object at a speed corresponding to the moving object. This results in an image of the moving object continuous over time. Stationary portions of the scene are dispersed over the film and are not discemable.

U.S. Pat. No. 4,797,751 to Yamaguchi on Jan. 10, 1989, “Electronic camera apparatus for recording and reproducing moving object images,” describes a video slit camera with a single fixed vertical line sensor. The sensor output is scanned to form an image of a moving object passing a finish line.

U.S. Pat. No. 5,301,026 to Lee on Apr. 5, 1994, “Picture editing apparatus in a digital still video camera system,” describes a picture editor for a digital still video camera. The editor is capable of mixing pictures and displaying the mixed picture as a new video image.

U.S. Pat. No. 5,552,824 to DeAngelis et al. on Sep. 3, 1996, “Line object scene generation apparatus,” describes a system for recording and displaying a time-sequential scene on a computer. A digital camera transmits a sequence of frames to a timer representative of the image of an object passing a plane in space. Each frame represents a vertical slice of a moving object, thus forming a fractional part of the scene. The user can edit and view the frames in various ways such as adjusting pixel intensities, time-marking the images, cropping, etc.

One problem with most prior art slit cameras is that the user has very little control over the configuration of the scan line, the scan rate, and how pixels of the scan lines are combined into the output image. In almost all cases, the scan line is vertical and moves horizontally at a predetermined rate. Another problem is that most prior art slit cameras require specialized expensive equipment. Thus, prior art slit cameras are of little use to the casual user for generating artistic images.

### SUMMARY OF THE INVENTION

A slit camera system and method generates and displays an image of a moving object. First, a user defines one or more scan lines. Then, a sequence of frames of the moving object are acquired.

From each frame, pixels corresponding to a current position of the scan line are selected. The selected pixels are stored in a static portion of an image buffer and remaining pixels of the frame are stored in a dynamic portion of the image buffer without overwriting any pixels of the static portion to display a distorted image of the moving object.

### BRIEF DESCRIPTION OF THE DRAWINGS

FIG. 1 is a side view of the slit camera system according to the invention;

FIG. 2 is a front view of the slit camera system according to the invention;

FIGS. 3 and 4 are front views of the slit camera system with an output image and a moving scan line;

FIG. 5 is a front view of the slit camera system with an output image and multiple moving scan lines;

FIG. 6 is a block diagram of a slit camera method according to the invention; and

FIG. 7 is an example of an output image created using the invention.

### DETAILED DESCRIPTION OF THE PREFERRED EMBODIMENT

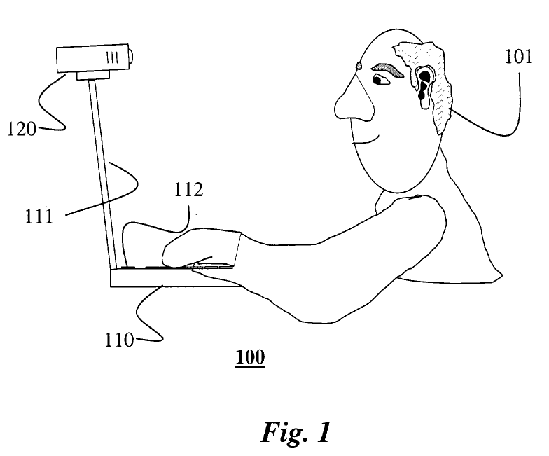

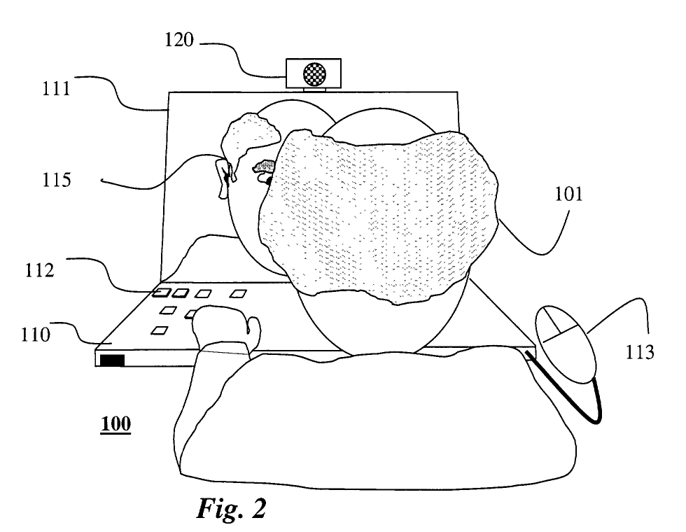

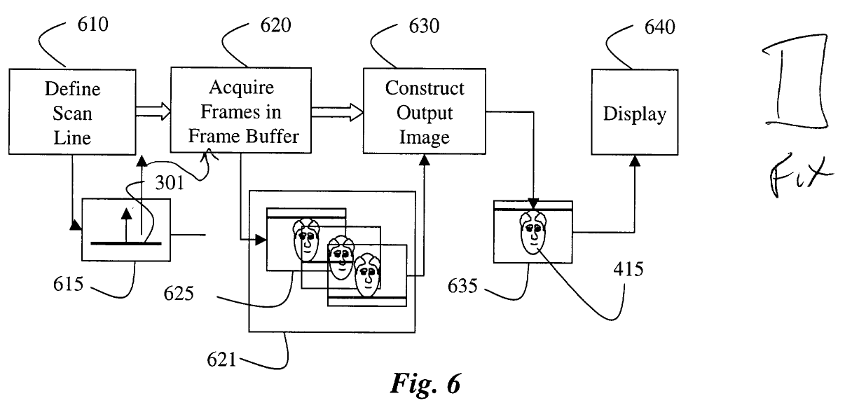

FIGS. 1 and 2 are side and front views of an artistic slit camera system 100 according to the invention. The system 100 includes a computer 110 and a camera 120. The computer is conventional, e.g., a workstation, PC or laptop. The computer includes a screen 111 for displaying output images 115, input devices, e.g., a keyboard 112 and mouse 113 for entering commands. The camera 120 can be an inexpensive “Web” camera. The camera acquires a sequence of frames that can be stored in a frame buffer memory of the computer. The computer also includes an image buffer 635, see FIG. 6. Pixels stored in the image buffer are displayed on the screen 111.

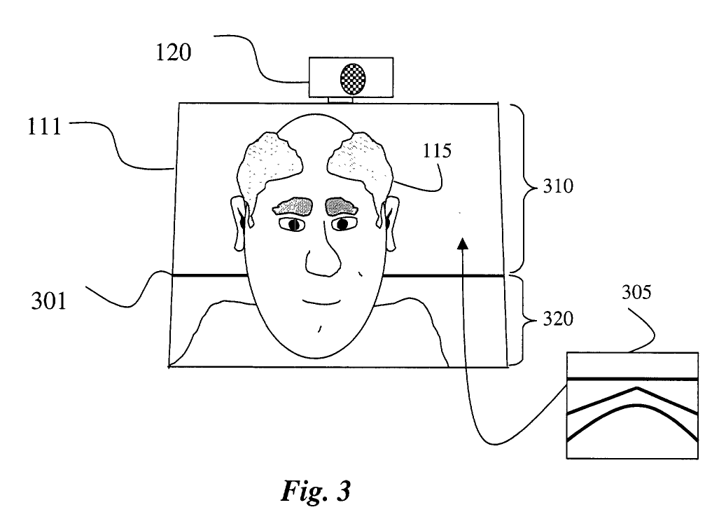

As shown in FIGS. 3-6, the system 100 generates an artistic digital image of a user 101 using scan line portions of the sequence of frames 625. During operation, the user 101 is typically in front of the system facing the camera 120. Thus, the user can watch and control the artistic imaging process in a dynamic manner.

With the input devices, the user 101 first defines 610 characteristics 615 of a scan line 301. The scan line 301 can be selected from predefined 305, or user designed. The characteristics of the scan line can include shape, e.g., straight, angular, curved, circular, rectangular, diamond, etc., an orientation, e.g., horizontal, vertical, diagonal, a directions of scanning, e.g., top-to-bottom or right-to-left, width, e.g., one ore multiple pixel widths, and a scanning speed, including a variable speed. The well known Bresenham algorithm can also be used.

Thus, the characteristics of the scan line also specifying a starting position and end position of the scan line in the frames. Multiple scan lines can be defined, as described below. One complete scan has a beginning scan line position and an ending scan line position.

After the characteristics 615 of the scan line 301 has been defined 615, a sequence of frames 625 is acquired 620 while the user moves in front of the camera 120 and the scan line 301 moves with respect to the frames according to the characteristics 615, e.g., storing at the bottom, and moving upwards until the top scan line is reached.

The artistic output image 115-415 is constructed 630 in an image buffer 635 as follows. The output image has a dynamic portion 310 and a static portion 320. As the scan line moves across the frames, pixels corresponding to the moving scan line 301 are selected from the frames in the frame buffer 621. The selected pixels are stored in the image buffer 635 to form the static portion 320. Pixels that form part of the static portion are not modified by stored pixels selected from subsequence frames.

The dynamic portion 310 is refreshed from the remaining portions of the frames until the scan line has moved across the entire field of view, and a complete final artistic static image 415 has been generated and displayed 640 on the screen 111.

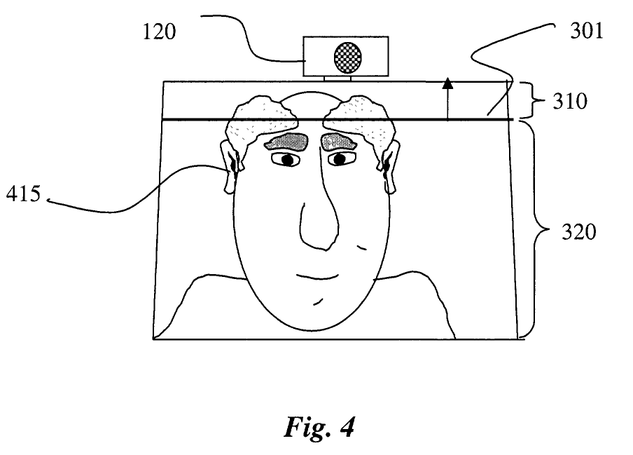

For example, when the scan line 301 is horizontal and moves upwards as shown in FIGS. 3 and 4, pixels from the bottom scan line are selected from the first frame, then pixels from the second scan line, and so forth, until the top scan line is reached. If the frames are an NTSC (640×480) video stream, which produce thirty frames per seconds, then the process takes sixteen seconds to complete. Because the user is moving, as in any slit camera system, the final image 415 will be artistically distorted, only limited by the imaginative maneuvers of the user. The output image is thus a seamless blend of portions of the frames collected over time.

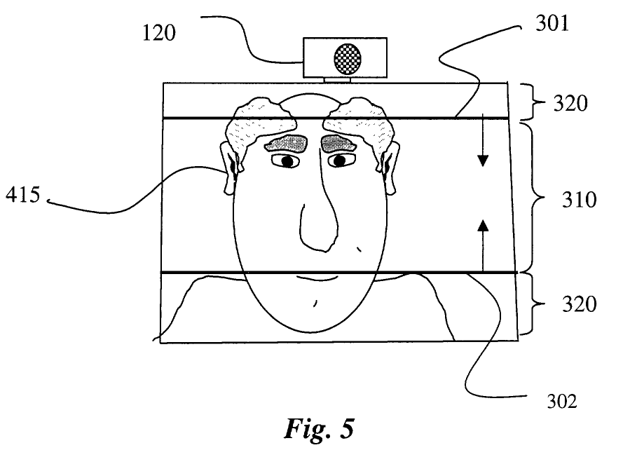

As shown in FIG. 5, it is also possible to define characteristics for multiple scan lines 301-302. In this case, the final image is complete, when the two scan lines meet. The scan lines 301-302 can have different characteristics, such as orientation and speed. In addition, pixels can be mixed by transparency from multiple scan line positions. This technique artistically softens the appearance of the final image.

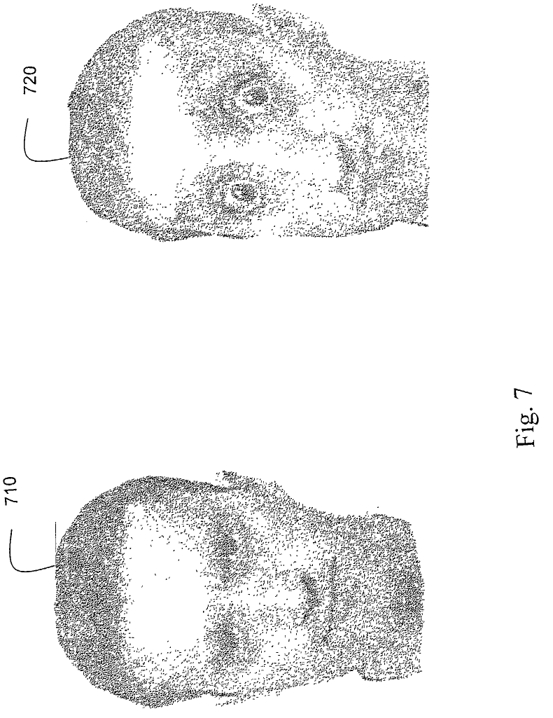

During image construction, the user can follow the motion of the scan line or move in an opposite direction. It is also possible for the user to rotate around an axis perpendicular or parallel to the scan line. The user can also move forward and backward to change size while adjusting the characteristics of the scan line. FIG. 7 shows that a combination of moves will warp the output image 720 of the user 710 in interesting ways. All of these variations produce different artistic effects.

It should also be noted that the invention can be used with mobile devices such as personal digital assistants (PDAs) and cellular telephones. Many of these devices come equipped with a display screen and a built-in camera, or the image can be downloaded to the mobile device via a communications network. Thus, these devices can be personalized in interesting ways.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

1. A method for generating an image of a moving object, comprising:
defining characteristics of a scan line;
acquiring a sequence of frames of the moving object;
selecting, from each frame, pixels corresponding to a current position of the scan line while moving the scan line according to the characteristics with respect to the sequence of frames;
storing the selected pixels in a static portion of an image buffer; and
storing remaining pixels of the frame in a dynamic portion of the image buffer without overwriting any pixels of the static portion to display a distorted image of the moving object.

2. The method of claim 1 wherein the characteristics of the scan line are defined by a user while a camera acquires the sequence of frames of a face of the user.

3. The method of claim 1 wherein the characteristics of the line include a shape, an orientation, and a direction of scanning.

4. The method of claim 3 wherein the characteristics of the line further include a speed of scanning.

5. The method of claim 4 wherein the speed is variable.

6. The method of claim 3 wherein the characteristics of the line further include a width.

7. The method of claim 3 wherein the shape of the line is curved.

8. The method of claim 1 wherein characteristics of multiple scan lines are defined, and pixels for the static portion are selected from the multiple scan lines.

9. The method of claim 1 wherein pixels are selected according to a Bresenham algorithm.

10. The method of claim 1 further comprising:
mixing the selected pixels with pixels of the static position according to transparency.

11. The method of claim 1 wherein the image is displayed on a mobile device.

12. The method of claim 1 wherein the mobile device is a cellular telephone.

13. The method of claim 12 wherein the mobile device includes a camera for acquiring the sequence of frames.

14. A system for generating an image of a moving object, comprising:
an input device configured to define characteristics of a scan line;
a camera configured to acquire a sequence of frames of the moving object;
a frame buffer configured to store each frame and for selecting from each frame pixels corresponding to a current position of the scan line while the scan line moves according to the characteristics with respect to the sequence of frames;
an image buffer configured to store the selected pixels in a static portion and to store remaining pixels of the frame in a dynamic portion without overwriting any pixels of the static portion;
an output device configured to display a distorted image of the moving object from the image buffer.
